(19) United States
(12) Patent Application Publication
(10) Pub. No.: US 2025/0276377 A1
(43) Pub. Date: Sep. 4, 2025

(54) ADAPTIVE MACHINING USING BUILD SURFACE TOPOLOGY FOR ADDITIVE MANUFACTURING SYSTEMS

(71) Applicants: Rolls-Royce Corporation, Indianapolis, IN (US); Rolls-Royce plc, London (GB)

(72) Inventors: Scott Nelson, Indianapolis, IN (US); David James Puhl, Indianapolis, IN (US); Clive Grafton-Reed, London (GB); Peter E. Daum, Indianapolis, IN (US); Robert F. Proctor, Indianapolis, IN (US); Christopher P. Heason, London (GB)

(21) Appl. No.: 18/593,672

(22) Filed: Mar. 1, 2024

(51) Int. Cl. B22F 10/85; B22F 10/28; B22F 10/66; B33Y 10/00; B33Y 30/00; B33Y 50/02

(52) U.S. Cl. CPC B22F 10/85; B22F 10/28; B22F 10/66; B33Y 10/00; B33Y 30/00; B33Y 50/02

(57) ABSTRACT

An additive manufacturing system includes an energy delivery device configured to deliver energy to a build surface of a component to form a melt pool in the build surface of the component, a powder delivery device configured to direct a powder stream toward the melt pool, a machining device configured to machine the build surface, at least one topology sensor configured to generate topological data representative of a topology of the build surface, and a computing device configured to receive the topological data from the at least one topology sensor for a plurality of layers, identify differences between the topological data and specification data representative of a set of tolerances of the build surface, control the energy delivery device and the powder delivery device based on a set of deposition parameters, and control the machining device to machine the build surface based on the identified differences.

### TECHNICAL FIELD

The disclosure relates to additive manufacturing techniques.

### BACKGROUND

Additive manufacturing generates three-dimensional structures through addition of material layer-by-layer or volume-by-volume to form the structure, rather than removing material from an existing component to generate the three-dimensional structure. Additive manufacturing may be advantageous in many situations, such as rapid prototyping, forming components with complex three-dimensional structures, or the like. In some examples, additive manufacturing may utilize powdered materials and may melt or sinter the powdered material together in predetermined shapes to form the three-dimensional structures. In addition to initial fabrication, additive manufacturing techniques may include subsequent machining processes to finish a component.

### SUMMARY

The disclosure describes additive manufacturing systems, and methods for operating additive manufacturing systems, that adaptively manufacture a component using topological data of a build surface. The topological data is obtained during initial fabrication of the component and provides information about the component that may not be available from topological scans of an as-fabricated component, including differences between target and as-deposited parameters of the build surface for various intermediate layers. The topological data may be used to control machining after deposition of the particular layer or after initial fabrication of the component, as the identified differences between the target and as-deposited parameters may indicate material or structural properties for which different machining parameters may be warranted. For example, topological variation in a section of a component may indicate differences in build quality, and correspondingly inform material removal parameters that account for the differences in build quality, such as lower (e.g., reduced) material removal rate for those particular sections. In this way, the additive manufacturing systems described herein may enable more accurate finishing of a fabricated component.

In some examples, the disclosure describes an additive manufacturing system that includes an energy delivery device, a powder delivery device, a machining device, one or more sensors, and a computing device. The energy delivery device is configured to deliver energy to a build surface of a component to form a melt pool in the build surface of the component. The powder delivery device is configured to direct a powder stream toward the melt pool. The machining device is configured to machine the build surface. The one or more sensors include at least one topology sensor configured to generate topological data representative of a topology of the build surface. The computing device is configured to receive the topological data from the at least one topology sensor for a plurality of layers and identify differences between the topological data and specification data representative of a set of tolerances of the build surface. The computing device is further configured to control the energy delivery device and the powder delivery device based on a set of deposition parameters, and control the machining device to machine the build surface based on the identified differences.

In some examples, the disclosure describes a method that includes receiving, by one or more computing devices, topological data from one or more sensors of an additive manufacturing system. The additive manufacturing system includes an energy delivery device configured to deliver energy to a build surface of a component to form a melt pool in the build surface of a component, a powder delivery device configured to direct a powder stream toward the melt pool, a machining device configured to machine the build surface, and the one or more sensors. The one or more sensors include at least one topology sensor configured to generate the topological data representative of the topology of the build surface. The method further includes identifying, by the one or more computing devices, differences between the topological data and specification data representative of a set of tolerances of the build surface. The method further includes controlling, by the one or more computing devices, the energy delivery device and the powder delivery device based on a set of deposition parameters, and controlling, by the one or more computing devices, the machining device to machine the build surface based on the identified differences.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual block diagram illustrating topology monitoring aspects of an example additive manufacturing system that includes a topology sensor configured to monitor topology of a build surface within the additive manufacturing system during an additive manufacturing technique.

FIG. 2 is a process flow diagram illustrating a mass flux and heat flux monitoring and control technique.

FIG. 3A is a flowchart illustrating an example method for fabricating a component using topological data.

FIG. 3B is a flowchart illustrating an example method for generating machining data using topological data.

FIG. 3C is a cross-sectional side view diagram illustrating an intermediate build of a component that includes topological defects.

FIG. 3D is a cross-sectional side view diagram illustrating identification of topological defects in an intermediate build of a component.

FIG. 3E is a cross-sectional side view diagram illustrating generation of machining data that accounts for topological defects.

FIG. 4A is a flowchart illustrating an example method for fabricating a component using topological data.

FIG. 4B is a flowchart illustrating an example method for generating machining data using topological data.

FIG. 4C is a cross-sectional side view diagram illustrating an intermediate build of a component that includes topological defects.

FIG. 4D is a cross-sectional side view diagram illustrating identification of topological defects in an intermediate build of a component.

FIG. 4E is a cross-sectional side view diagram illustrating machining of topological defects.

FIG. 4F is a cross-sectional side view diagram illustrating deposition of an overlying layer on the machined layer.

FIG. 5A is a flowchart illustrating an example method for fabricating a component using topological data.

FIG. 5B is a flowchart illustrating an example method for generating adjusted deposition parameters using topological data.

FIG. 5C is a cross-sectional side view diagram illustrating an intermediate build of a component that includes topological defects.

FIG. 5D is a cross-sectional side view diagram illustrating identification of topological defects in an intermediate build of a component.

FIG. 5E is a cross-sectional side view diagram illustrating deposition of a subsequent layer that accounts for the topological defects of the underlying layer.

FIG. 6A is a conceptual diagram illustrating an example machine learning model.

FIG. 6B is a conceptual diagram illustrating an example training process for a machine learning model.

### DETAILED DESCRIPTION

The disclosure generally describes techniques and systems for monitoring topology of a component during a blown powder additive manufacturing technique, such as a directed energy deposition (DED) technique, and using the measured topology in a subsequent machining technique, such as milling. During blown powder additive manufacturing, a component is built up by adding material to the component in sequential layers, such that the final component is composed of a plurality of layers of material. In blown powder additive manufacturing techniques for forming components from metals or alloys, an energy source may direct energy at a substrate to form a melt pool, and a powder delivery device may deliver a powder to the melt pool. At least some of the powder at least partially melts and is joined to the melt pool and, thus, the substrate. Once the initial fabrication is complete, various surfaces of the component may be further finished through machining to bring the component to desired dimensions and/or provide the component with a desired surface finish.

The properties of the final component, including the presence or absence of material defects and the resulting microstructure, are a function of a number of variables related to mass flux and heat flux. As such, measurement of mass flux and heat flux within the blown powder additive manufacturing system may enable characterization or prediction of final component properties, control of the blown powder additive manufacturing technique, quality assurance for the final component, and the like. Mass flux and heat flux measurements may relate to parameters of powder flow rate and melt pool size and temperature, respectively, and may not provide an accurate characterization of an as-deposited layer. For example, while mass flow may be measured along various points in a flow path of the powder, turbulence and other conditions near a deposition surface may cause variation in a deposition rate at a particular portion of a layer.

Due to inherent limitations of these and optical measurement techniques, material defects may not be detected by mass flux or heat flux measurements, and may not be detectable by external surface scans of the final component. However, such material defects may impact various mechanical properties, such as hardness and brittleness, that influence how material is removed from the component during finishing. For example, a portion of a material that includes various defects that result in higher brittleness may be machined differently than a portion of a material that is relatively defect-free. As a result, without information as to how the various intermediates layers were formed, subsequent machining steps may either undercompensate for the material defects by machining all surfaces of the component at less sensitive parameters (e.g., higher material removal rate) or overcompensate for the material defects by machining all surfaces of the component at more sensitive parameters (e.g., lower material removal rate).

In accordance with techniques of this disclosure, an additive manufacturing system may include a topology sensor for measuring a topology of material of the build surface added to the melt pool and a computing device that adaptively controls machining based on the topology of the build surface. The topology of the build surface may provide additional and/or alternative information for determining the properties of the final component, including defects and variations in microstructure of intermediate layers. For example, a localized difference in height within a layer may indicate a material defect or other change in microstructure that is actionable during subsequent machining, either immediately after deposition of the particular layer or after fabrication of the final component. The topology sensor may output topological data to the computing device, which analyzes the topological data and generates a model that represents the as-fabricated component, including defects in the final component indicated by the topological data. The computing device may further control a machining device to machine the as-fabricated component based on the model in a manner that accounts for the defects of the as-fabricated component indicated by the topological data. For example, the computing device may select machining parameters for machining portions of the component that include sub-surface defects that better preserve the integrity of the component. By monitoring the topology of the build surface of various layers during fabrication of the component, the systems described herein may enable a more complete representation of the final properties of the component for subsequent machining, and accordingly, more effectively and/or efficiently control operation of the machining device.

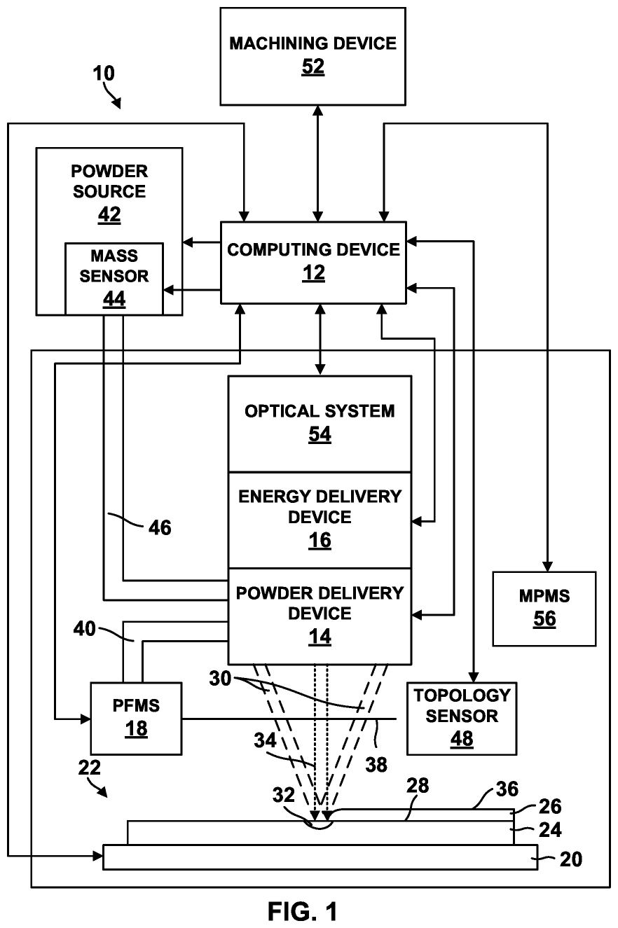

FIG. 1 is a conceptual block diagram illustrating an example manufacturing system 50 that includes an additive manufacturing system 10 configured to monitor a topology of a component 22 during an additive manufacturing technique. In the example illustrated in FIG. 1, additive manufacturing system 10 includes a computing device 12, a powder delivery device 14, an energy delivery device 16, a powder flow monitoring system (PFMS) 18, a melt pool monitoring system (MPMS) 56, an optical system 54, a stage 20, a powder source 42, a powder source mass sensor 44, a topology sensor 48, and in some examples, a machining device 52.

Stage 20 is configured to position component 22 during an additive manufacturing process. In some examples, stage 20 is movable relative to energy delivery device 16 and/or energy delivery device 16 is movable relative to stage 20. Similarly, stage 20 may be movable relative to powder delivery device 14 and/or powder delivery device 14 may be movable relative to stage 20. Stage 20 may be configured to selectively position and restrain component 22 in place relative to stage 20 during manufacturing of component 22.

Powder source 42 is the source of powder for powder stream 30. Powder source 42 may include any suitable container or enclosure, such as a hopper, configured to hold powder. Powder source 42 also may include mechanism for entraining the powder in a gas flow. For instance, powder source 42 may be coupled to a gas source, which provides a gas flowing through powder source 42 and entraining powder within the gas flow. Additionally, or alternatively, powder source 42 may include an agitator configured to agitate the powder and increase entrainment of the powder in the gas stream. System 10 may include a powder source mass sensor 44 associated with powder source 42. Powder source mass sensor 44 may be configured to quantify loss of mass in the powder source 42 or, alternatively, a mass flow out of powder source 42.

Powder source 42 is fluidically coupled to powder delivery device 14 via a flow path 46. Flow path 46 may include any suitable structure(s) defining an enclosed flow between powder source 42 and powder delivery device, including conduit, pipe, tubes, or the like. Although not shown in FIG. 1, for at least part of flow path 46 between powder source 42 and nozzles of powder delivery device 14, flow path 46 may split into multiple, parallel sections, e.g., one for each nozzle. Further, although not shown in FIG. 1, in some examples, flow path 46 may include one or more nozzles for controlling flow through flow path 46 as a whole or portions of flow path 46 (e.g., a section associated with a particular nozzle of powder delivery device 14).

Powder delivery device 14 may be configured to deliver powder to selected locations of component 22 being formed via a powder stream 30. Powder delivery device 14 may include one or more nozzles that each output powder, such that the combined powder defines powder stream 30 focused at a focus plane. As powder delivery device 14 is movable in the z-axis shown in FIG. 1 relative to component 22, the focal plane of powder delivery device 14 also may be movable in the z-axis relative to component 22, such that the focus plane may be controlled to be substantially coincident with build surface 28.

In some examples, powder delivery device 14 may be mechanically coupled or attached to energy delivery device 16 to facilitate delivery of powder stream 30 and energy 34 for forming melt pool 32 to substantially the same location adjacent to component 22. Energy delivery device 16 may include an energy source, such as a laser source, an electron beam source, plasma source, or another source of energy that may be absorbed by component 22 to form a melt pool 32 and/or be absorbed by powder in powder stream 30 to be added to component 22. Example laser sources include a CO laser, a CO₂ laser, a Nd:YAG laser, or the like. In some examples, the energy source may be selected to provide energy with a predetermined wavelength or wavelength spectrum that may be absorbed by component 22 and/or the powder to be added to component 22 during the additive manufacturing technique.

In some examples, energy delivery device 16 also includes an energy delivery head, which is operatively connected to the energy source. The energy delivery head may aim, focus, or direct energy 34 toward predetermined positions at or adjacent to a surface of component 22 during the additive manufacturing technique. As described above, in some examples, the energy delivery head may be movable in at least one dimension (e.g., translatable and/or rotatable) under control of computing device 12 to direct the energy toward a selected location at or adjacent to a surface of component 22.

As shown in FIG. 1, energy delivery device 16 may be arranged or configured such that energy 34 and powder stream 30 both exit from a common deposition head and are directed toward build surface 28. For instance, energy 34 may pass through a central channel within the deposition head and exit a central aperture in the deposition head, while fluidized powder may flow through internal channels and powder nozzle(s) for forming powder stream 30 and directing powder stream 30 toward build surface 28. At least some of the powder in powder stream 30 may impact a melt pool 32 in component 22, and at least some of the powder that impacts melt pool 32 may be joined to component 22.

During additive manufacturing, component 22 is built up by adding material to component 22 in sequential layers. The final component is composed of a plurality of layers of material. Energy delivery device 16 may direct energy 34 at first layer 24 to form melt pool 32. Powder delivery device 14 may deliver powder stream 30 to melt pool 32, where at least some of the powder at least partially melts and is joined to first layer 24. Melt pool 32 cools as energy 34 is no longer delivered to that location of first layer 24 (e.g., due to energy delivery device 16 scanning energy 34 over the surface of first layer 24). The temperature and cooling rate of melt pool 32 and the surrounding areas of first layer 24 affect the microstructure of the component 22 formed using the additive manufacturing technique.

System 10 may include both mass flow monitoring and heat flow monitoring. To provide mass flow monitoring, system 10 may include powder flow monitoring system (PFMS) 18. PFMS 18 is configured to image at least a portion of powder stream 30 to detect powder flowing between powder delivery device 14 and build surface 28. For example, PFMS 18 may include an illumination device and an imaging device. In some examples, the illumination device may include one or more light sources. For instance, the illumination device may include one or more structured light devices, such as one or more lasers. The illumination device is configured to illuminate a plane of powder stream 30 at image plane 38, e.g., a plane substantially perpendicular to an axis extending between powder delivery device 14 and build surface 28. The imaging device of PFMS 18 is configured to image at least some of the illuminated powder. The imaging device may have a relatively high data acquisition speed (e.g., frame rate), such greater than 1000 Hz. To provide heat flow monitoring, system 10 may include melt pool monitoring system (MPMS) 56. MPMS 56 is configured to image at least a portion of melt pool 32 to detect parameters, such as size, temperature, or shape, of melt pool 32. For example, MPMS may be communicatively coupled to optical system 54 for observing thermal emissions around melt pool 32 and a thermal camera for monitoring a size and/or temperature of melt pool 32.

Optical system 54 may include an imaging device and an associated optical train, which senses emissions at or near component 22 during the additive manufacturing technique. For example, optical system 54 may include a visible light imaging device, an infrared imaging device, or an imaging device that is configured (e.g., using a filter) to image a specific wavelength or wavelength range. The optical train may include one or more reflective, refractive, diffractive optical components configured to direct light to the imaging device. For example, the optical train may be configured to direct light from near component 22 and/or melt pool 32 to the imaging device.

System 10 further includes a topology sensor 48. Topology sensor 48 is configured to generate topological data representative of a topology of build surface 28. Topological data may include any absolute or relative quantitative dimensional measurement of features on build surface 28. As will be discussed further below, in addition to representing a topology of build surface 28, topological data may also be used to at least partially determine a morphology of a build layer that is indicated by the topology of the build layer, alone or in combination with other measured or known parameters. As a result, topological data obtained for intermediate layers of component 22 may be used to select machining parameters for machining portions of the intermediate layers.

Topology sensor 48 may include any of a variety of sensors that utilize optical profilometry techniques including, but not limited to, interference profilometry, focus detection profilometry, pattern projection profilometry, or the like. In some examples, topology sensor 48 includes a laser and a sensor (e.g., an imaging device), which senses laser light reflected by the structure being imaged (e.g., melt pool 32 and the added material). The laser may have a defined wavelength, which may affect the resolution of the topology sensor 48. In some examples, the wavelength and sensor may be selected such that the resolution of topology sensor 48 is as great as about 10 microns (e.g., about 6 microns). In some examples, topology sensor 48 may be positioned substantially directly above component 22 and may include an interferometer, which provides depth information based on the time from outputting a laser pulse to the sensing of the reflected light. In other examples, topology sensor 48 may be positioned at an offset with respect to component 22 such that the sensor senses depth information without using an interferometer.

Additive manufacturing system 10 may include machining device 52. Machining device 52 may be configured to adaptively machine component 22 during a concurrent or subsequent subtractive manufacturing technique as part of the additive manufacturing process. In some examples, machining device 52 is configured to machine component 22 during initial fabrication of component 22. For example, machining device 52 may be configured to selectively machine portions of a particular layer 24, 26, after deposition of the respective layer. In some examples, machining device 52 is configured to machine component after initial fabrication of component 22. For example, machining device 52 may be configured to selective machine portions of a surface and/or subsurface of component 22 after deposition of layers of component 22 is complete. A variety of machining devices may be used including, but not limited to, cutting machines, milling machines, grinding machines, turning machines (e.g., lathes), drilling machines, boring machines, or the like.

Computing device 12 is configured to control components and operation of system 10 and may include, for example, a desktop computer, a laptop computer, a workstation, a server, a mainframe, a cloud computing system, or the like. Computing device 12 may be communicatively coupled to, and configured to control, powder delivery device 14, energy delivery device 16, PFMS 18, optical system 54, MPMS 56, stage 20, powder source 42, powder source mass sensor 44, and/or topology sensor 48 using respective communication connections. Although FIG. 1 illustrates a single computing device 12 and attributes all control and processing functions to that single computing device 12, in other examples, system 10 may include multiple computing devices 12, e.g., a plurality of computing devices 12.

Computing device 12 may be configured to control operation of powder delivery device 14, energy delivery device 16, adjustable z-stage 40, stage 20, and/or topology sensor 48 to position component 22 relative to powder delivery device 14, energy delivery device 16, PFMS 18, MPMS 56, and/or topology sensor 48 during additive manufacturing processes. For example, as described above, computing device 12 may control stage 20 and powder delivery device 14, energy delivery device 16, adjustable z-stage 40 and/or topology sensor to translate and/or rotate along at least one axis to position component 22 relative to powder delivery device 14, energy delivery device 16, PFMS 18, MPMS 56, and/or topology sensor 48. Positioning component 22 relative to powder delivery device 14, energy delivery device 16, PFMS 18, MPMS 56, and/or topology sensor 48 may include positioning a predetermined surface (e.g., a surface to which material is to be added) of component 22 in a predetermined orientation relative to powder delivery device 14, energy delivery device 16, PFMS 18, MPMS 56, and/or topology sensor 48.

Computing device 12 may be configured to control system 10 to deposit layers 24 and 26 to form component 22 based on a set of deposition parameters. The set of deposition parameters may include energy, feed, and motion parameters that are configured to produce layers 24, 26, having various physical parameters, such as a height of layers 24, 26, and a density of layers 24, 26. For example, the set of deposition parameters may include power, beam diameter, beam profile, and wavelength of energy delivery device 16; powder feed rate and gas feed rate of powder delivery device 14; scan speed and deposition path of stage 20 relative to energy delivery device 16 and powder delivery device 14; or any other operating parameters that may affect an amount and/or quality of material formed as layers 24, 26.

Computing device 12 may be configured to select deposition parameters that are configured to generate layers 24, 26, according to the desired physical parameters. As shown in FIG. 1, component 22 may include a first layer 24 and a second layer 26, although many components may be formed of additional layers, such as tens of layers, hundreds of layers, thousands of layers, or the like. Component 22 in FIG. 1 is simplified in geometry and the number of layers compared to many components formed using additive manufacturing techniques. Although techniques are described herein with respect to component 22 including first layer 24 and second layer 26, the technique may be extended to components 22 with more complex geometry and any number of layers.

To form component 22, computing device 12 may control powder delivery device 14 and energy delivery device 16 according to the set of operating parameters to form, on a surface 28 of first layer 24 of material, a second layer 26 of material. Computing device 12 may control energy delivery device 16 to deliver energy 34 to a volume at or near surface 28 to form melt pool 32. For example, computing device 12 may control the relative position of energy delivery device 16 and stage 20 to direct energy to the volume. Computing device 12 also may control powder delivery device 14 to deliver powder stream 30 to melt pool 32. For example, computing device 12 may control the relative position of powder delivery device 14 and stage 20 to direct powder stream 30 at or on to melt pool 32.

Computing device 12 may control powder delivery device 14 and energy delivery device 16 to move energy 34 and powder stream 30 along build surface 28 in a pattern until layer 26 is complete. Computing device 12 may then control a z-axis position of stage 20 and/or powder delivery device 14 and energy delivery device 16 such that melt pool 32 will be formed on surface 36 of second layer 26, and may control powder delivery device 14 and energy delivery device 16 to move energy 34 and powder stream 30 along build surface 28 in a pattern until layer 26 is complete.

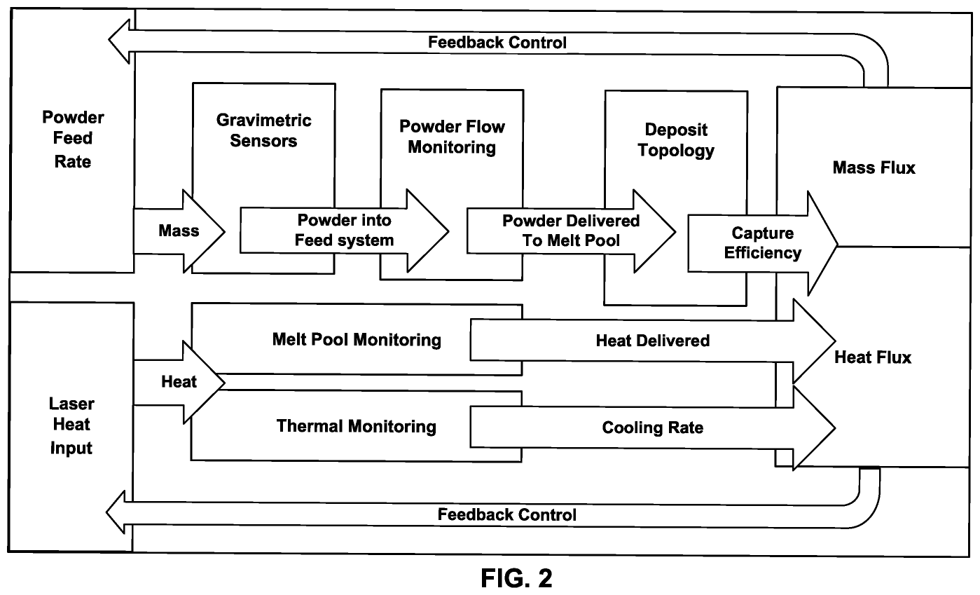

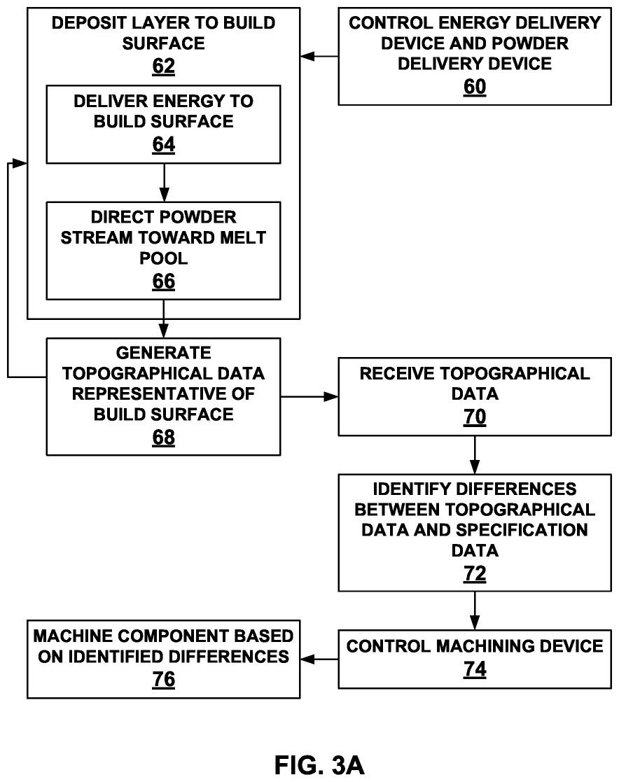

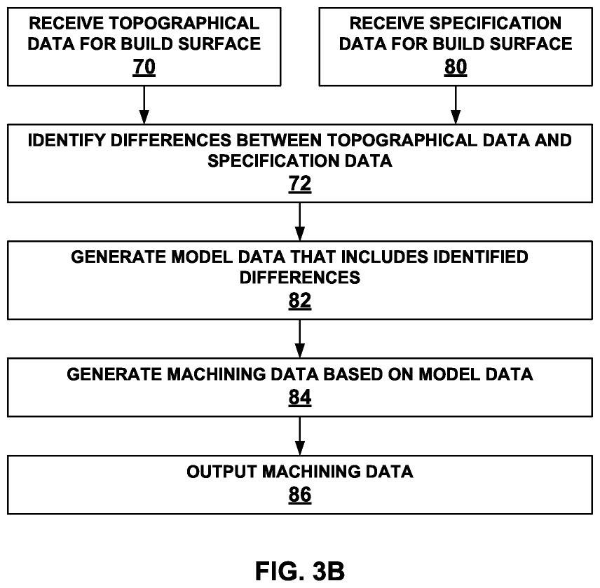

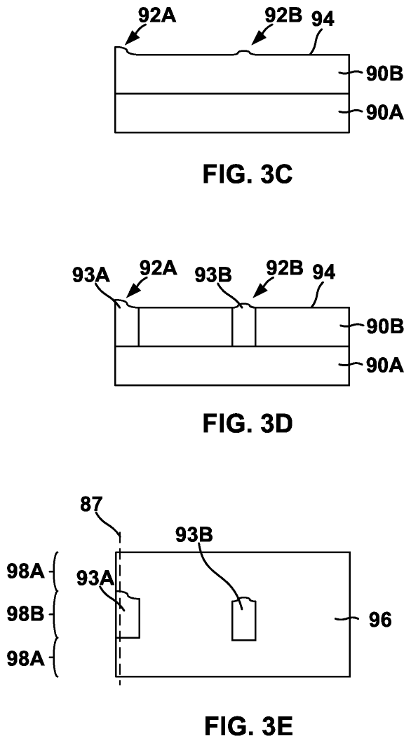

System 10 may be configured with various in-situ monitoring techniques, including mass flux monitoring, heat flux monitoring, and topology monitoring, to control an additive manufacturing process and a subsequent subtractive manufacturing process. FIG. 2 is a process flow diagram illustrating a mass flux and heat flux monitoring and control technique. The technique of FIG. 2 may be implemented by system 10 of FIG. 1 and will be described with concurrent reference to FIG. 1. However, it will be appreciated that system 10 may perform other techniques and the technique of FIG. 3 may be performed by other systems.

Computing device 12 may be configured to control a powder feed rate output by powder source 42 (see top left of FIG. 2). For instance, computing device 12 may be configured to control an agitator of powder source 42, a gas flow rate of gas flowing through powder source 42, a position of one or more valves within flow path 46, or the like to control a powder feed rate output by powder source 42.

Computing device 12 may be configured to receive data from one or more mass flow monitoring sensors, including PFMS 18 and/or powder source mass sensor 44. Data received from powder source mass sensor 44 indicates a mass flow of powder from powder source 42 to powder delivery device. Data from PFMS 18 indicates a mass flow of powder in powder stream 30 between powder delivery device 14 to adjacent melt pool 32. In some examples computing device 12 may be configured to further receive topological data from topology sensor 48. Data from topology sensor 48 indicates a topology of build surface 28, and may further indicate powder mass captured by melt pool 32 and added to component 22.

Computing device 12 may calculate one or more mass flow-related metrics based on the data received from PFMS 18, powder source mass sensor 44, and/or topology sensor 48. For example, one or more computing devices 12 may determine a capture efficiency by determining a fraction or percentage of powder from powder stream 30 that is captured by melt pool 32 and added to component 22, e.g., by dividing the powder mass captured by melt pool 32, as determined based on data from topology sensor, into the mass flow determined based on data received from PFMS 18. Further, computing device 12 may determine an overall mass flux using the data received from PFMS 18, powder source mass sensor 44, and/or topology sensor 48. One or more computing devices 12 then may use the overall mass flux as an input to the control algorithm used to control the powder feed rate output by powder source 42 (see top left of FIG. 2).

Similarly, computing device may be configured to control energy delivery device 16 to deliver energy 34 to first layer 24 to establish a given heat input (see bottom left of FIG. 2). For example, one or more computing device 12 may control one or more operating parameters of energy delivery device 16, such as intensity, pulse rate, pulse width, or the like; one or more positional parameters related to energy delivery device 16, such as dwell time at a location, a movement rate relative to first layer 24, an overlap between adjacent passes of energy 34 across first layer 24, a pause time between adjacent passes of energy 34 across first layer 24, or the like to control heat input to system 10 (e.g., to melt pool 32 and component 22).

Computing device 12 may be configured to receive data from one or more heat sensors, such as optical system 54 and/or MPMS 56. Computing device 12 may determine a cooling rate and associated heat from using data from optical system 54 and may determine a heat input into component using a size and/or temperature of melt pool 32 as observed by melt pool monitor. Computing device 12 may be configured to determine an overall heat flux using these data. Computing device 12 may then use the overall heat flux as an input to the control algorithm used to control the energy delivery by energy delivery device 16 (see top left of FIG. 2). In some examples, computing device 12 may also use the deposit topology (captured powder mass) and/or capture efficiency metric in the determination of the heat flux, as the added powder mass and quench effects associated with the captured powder affect the cooling rate.

During an additive manufacturing process, various defects or deviations may occur in build surface 28. These defects or deviations may occur due to changes in operating and material parameters including, but not limited to: powder type, shape, size, distribution, and porosity; laser power; powder flow rate; scan speed, pattern, and length; gas flow rate and direction; gas flow composition; scan pattern; and any other parameter in which deviation may introduce anomalies in formation of a layer. Defects in layers 24, 26, may at least partly manifest as topological deviations in build surface, such that a topology of build surface 28 may indicate the presence of the defects. Defects or deviations may manifest as local defects that only affect a particular portion of a layer, such as due to a temporary change in deposition conditions within a particular layer, or may manifest as global defects that affect an entire layer, such as a gradual change in deposition conditions over a sequence of layers.

In some instances, defects may include surface defects. Surface defects may include defects that are present at and limited to build surface 28. As one example, a surface defect may include a planar deviation from a plane of build surface 28, such as variation in thickness of the layer. Such planar deviation may occur, for example, due to variations in powder flow rate or warping due to spatial or temporal variation in temperature. As another example, a surface defect may include surface roughness in build surface 28, such as localized projections in build surface 28. Such surface roughness may occur, for example, due to variations in powder size or spatter.

In some instances, defects may include sub-surface defects. Sub-surface defects may include defects that are present at build surface 28, but may extend into the layer. As one example, a sub-surface defect may include pores in the layer that manifest as cavities in build surface 28. Such pores may occur, for example, due to lack of fusion of particles or gas trapped during the deposition. As another example, a sub-surface defect may include inclusions, such as large or foreign powder, that manifest as irregularly-shaped embedded particles. Such inclusions may occur, for example, due to contamination or inconsistent size of powder. As another example, a sub-surface defect may include unfused particles that may manifest as shallow trenches. Such unfused particles may occur, for example, due to excessive powder flow rate or inadequate laser power.

In some instances, defects may include thickness deviations. Thickness deviations may include deviations that are present across build surface 28. As one example, a thickness deviation may include a gradual change in thickness between layers that manifests as a thicker or thinner layer. Such gradual change in thickness may occur, for example, due to a change in temperature of the intermediate build, resulting in gradually increasing thicknesses of each subsequent layer, or a change in build strategy of a particular layer due to a geometry of component 22, resulting in different deposition conditions for a same set of deposition parameters as the underlying layers.

Computing device 12 may be configured to receive topological data from topology sensor 48 that includes an indication of these defects or deviations. For example, topology sensor 48 may continuously scan build surface 28 during deposition of a respective layer 24, 26, or may scan build surface 28 after deposition of the respective layer 24, 26, is complete. In the example of FIG. 1, prior to formation of second layer 26 of material on first layer 24 of material, computing device 12 may receive topological data for first layer 24 of material from topology sensor 48. This topological data may represent a topology of build surface 28. The topology of build surface 28 may include local features or parameters, such as micron-scale features or roughness, or global features or parameters, such as planarity. The topological data may include a topology for each layer of the plurality of layers, and may be received in real-time as build surface 28 is scanned, once component 22 is fabricated, or at any other time prior to machining.

In some examples, additive manufacturing system 10 may be configured to adaptively machine component 22 based on topological data captured during initial fabrication of component 22. Computing device 12 may be configured to identify differences between the topological data and specification data representative of a set of tolerances of build surface 28. Differences between the as-deposited topology of build surface 28 represented by the topological data and the desired topology of build surface 28 may indicate a defect, deviation, or other anomaly. In some examples, computing device 12 may identify a location of the identified difference in the topological data. For example, computing device 12 may form a model of the as-deposited component 22 in which the location is marked. In some examples, computing device 12 may further characterize the identified difference based on various spatial characteristics of the identified difference, such as a pattern, shape, or magnitude of the identified difference or differences. Computing device 12 may control machining device 52 to machine build surface 28 and/or component 22 based on the identified differences.

In some examples, computing device 12 may be configured to control machining device 52 to machine component 22 after initial fabrication of component 22. As explained above, portions of component 22 may require further machining to achieve desired dimensions or finish, and portions of component 22 that include the defects may be more susceptible to damage than portions of component 22 that are deposited within specification. Computing device 12 may determine a toolpath for machining component 22 and operate machining device 52 along the toolpath such that a portion of component 22 that includes a defect may be machined differently than portions that do not include the defect. For example, computing device 12 may identify a sub-surface defect that is undetectable by a final optical scan of component 22, but that is indicated as including an identified difference by the topological data. Computing device 12 may control machining device 52 according to more sensitive conditions (e.g., slower) such that the sub-surface defect may be less likely to undergo damage in response to the machining operation.

FIG. 3A is a flowchart illustrating an example method for fabricating component 22 using topological data, including machining component 22 after initial fabrication is complete. The example method of FIG. 3A includes controlling energy delivery device 16 and powder delivery device 14 (60) to deposit a layer on build surface 28 based on a set of deposition parameters (62). For example, computing device 12 may send control signals to each of energy deliver device 16 and powder delivery device 14. In response to receiving the control signals, energy delivery device 16 delivers energy to build surface 28 of component 22 to form melt pool 32 in build surface 28 (64), and powder delivery device 14 directs powder stream 30 toward melt pool 32 (66).

The example method of FIG. 3A includes generating, by topology sensor 48, topological data representative of build surface 28 (68). For example, topology sensor 48 may use one or more optical techniques to scan build surface 28 and capture topological data representing a topology of build surface 28. The topological data may include a topology for each layer of the plurality of layers. The example method of FIG. 3A includes receiving topological data from topology sensor 48 of additive manufacturing system 10 (70). For example, computing device 12 may receive the topological data in real-time as build surface 28 is scanned, once component 22 is fabricated, or at any other time prior to machining.

The example method of FIG. 3A includes identifying, by computing device 12, differences between the topological data and specification data representative of a set of tolerances of build surface 28 (72). The identified differences may represent defects or other anomalies that may affect how the subsequent machining operation is performed, but that would otherwise go unnoticed if not for the captured topological data of each layer 24, 26.

The example method of FIG. 3A includes controlling machining device 52 to machine one or more portions of component 22 based on the identified differences (74). For example, while component 22 may be initially fabricated to dimensions similar to nominal dimensions of a finished part, such dimensions may require additional machining, particularly for portions of component 22 that may be configured with particular surface properties or that may be subject to small clearances or tolerances. As a result, computing device 12 may control machining device 52 based on a set of machining parameters that account for these identified differences to machine portions of component 22 that may be out of specification until component 22 is within tolerance. In response to receiving the control signals, machining device 52 machines component 22 based on the identified differences (76).

FIG. 3B is a flowchart illustrating an example method for generating machining data using topological data. The example method of FIG. 3B may be performed by computing device 12, such that computing device 12 may be configured to perform any of the steps of FIG. 3B. The example method includes receiving topographical data for build surface 28 (70), such as described in step 70 of FIG. 3A above. The example method of FIG. 3B further includes receiving specification data for build surface 28 (80). The specification data may represent an anticipated or desired topology of build surface 28 based on the set of deposition parameters selected for the particular layer. For example, the specification data may include a desired build height of the particular layer, such as relative to an underlying layer or relative to the build height at that particular layer.

FIG. 3C is a cross-sectional side view diagram illustrating an intermediate build of a component that includes topological defects 92A and 92B (referred to collectively as “defects 92”), such as may be indicated by the topological data. Defects 92 may include any defects in or on layer 90B that can be indicated by a topology of a build surface 94 of layer 90B. In the example of FIG. 3C, defects 92 are each indicated by a projection; however, other topological variations may indicate defects 92, such as depressions, cavities, ridges, troughs, or any other difference in topology detectable using optical detection techniques.

Referring back to FIG. 3B, the example method includes identifying differences between the topological data and specification data representative of a set of tolerances of build surface 28 (72), such as described in step 72 of FIG. 3A above. In some examples, the identified differences include a spatial location of a topological variation that exceeds a tolerance, such as x-, y-, and z-dimensions of the topological variation at x- and y-coordinates on or in the particular layer. In some instances, the topological variation may include only the portion of the layer that exceeds the tolerance. For example, a defect that results from highly localized over-deposition, such as surface roughness, may be limited to that portion of the layer outside the tolerance. In some instances, the topological variation may include an entire portion of the layer underlying the portion of the layer that exceeds the tolerance. For example, a defect that results from unfused powder may include the entire layer at that portion, rather than just the surface portion. FIG. 3D is a cross-sectional side view diagram illustrating identification of topological defects in an intermediate build of a component. In the example of FIG. 3D, defects 92A and 92B are indicated as respective regions 93A and 93B of identified differences.

In some examples, the identified differences may be further categorized based on various characteristics of the identified differences. For example, computing device 12 may analyze characteristics of each region 93 such as a magnitude (e.g., height or depth) of a corresponding defect 92, a size (e.g., width or length) of a corresponding defect, a pattern (e.g., relative distance) of two or more defects 92, a shape of a corresponding defect 92, or any other characteristic of defect 92 that may differentiate a type of defect. The type of defect may correspond to a material property that results from the defect. For example, a warping defect may indicate that the portion of build surface 28 has undergone a different thermal treatment, while a porous defect may indicate that the portion has a lower (e.g., different) density. Types of defects that may be categorized may include, but are not limited to, porosity, unfused powder, cavities, warping, and the like.

Referring back to FIG. 3B, the example method includes generating model data that includes the identified differences (82). The model data may represent an as-fabricated model of component 22, including an internal topology and/or morphology of build surfaces 28 that is based on the topological data and that includes the identified differences. For example, the identified differences may be indicated as spatial locations within the model data. FIG. 3E is a cross-sectional side view diagram illustrating generation of machining data that accounts for topological defects. Regions 93A and 93B are indicated within the model data, such that the presence and/or material characteristics of regions 93A and 93B can be considered when generating the machining data.

Referring back to FIG. 3B, the example method includes generating machining data based on the model data (84). Machining data may include a toolpath that corresponds to one or more excess portions of component 22 to be removed through machining, as well as the sets of machining conditions at those excess portions. Computing device 12 may compare the model data with the final part data to identify an excess portion of component 22 to be removed. In the example of FIG. 3E, such excess portion is indicated by machining line 87. This excess portion includes a portion of region 93A that is beneath a surface of component 22, and that may not otherwise be indicated by topological data of the surface of component 22.

Computing device 12 may further select the set of machining parameters for the excess portion. In some examples, the presence of defects 92 may indicate a general set of machining conditions. For example, regardless of a type of defect, presence of a defect within the excess portion may indicate a set of machining parameters that are less likely to cause damage or exacerbate existing damage caused by the defect. In the example of FIG. 3E, computing device 12 may select a first set of machining parameters 98A for portions of component 22 outside of regions 93A and a second set of machining parameters 98B for portions of component 22 within region 93A. The second set of machining parameters 98B may include a slower speed of an abrasive or cutting surface, a finer feature size of an abrasive surface, a shallower angle of an abrasive or cutting surface, selection of a newer cutting tool, a modified toolpath, or any other machining condition that may be less likely to damage a portion of component 22 having a lower material quality (e.g., higher porosity, lower strength, higher brittleness, etc.).

In some examples, the type of defects 92 may indicate a particular set of machining conditions. In the example of FIG. 3E, computing device 12 may select first set of machining conditions 98A for portions of component 22 outside of regions 93A and second set of machining conditions 98B for portions of component 22 within region 93A that are particular to the type of defect identified for defect 92A. A type of defect within the excess portion may indicate the use of a particular set of machining parameters that are less likely to cause damage to that particular type of defect. As one example, an unfused powder defect may be more brittle than portions that include fused powder, such that a lower speed of an abrasive surface may be used. As another example, a warping defect may be harder than portions that were not subject to the same high local temperature, such that a higher speed of an abrasive surface and/or a higher angle of an abrasive or cutting surface may be used.

Referring back to FIG. 3B, the example method includes outputting machining data (86). In response to receiving the machining data, machining device 52 may machine portions of component 22 that do not include defects according the first set of machining conditions and machine portions of component 22 that include region 93A according to the second set of machining parameters. As a result, component 22 may be machined more efficiently and/or effectively compared to machining processes that do not utilize topological data to determine subsequent machining conditions.

In some examples, computing device 12 may be configured to control machining device 52 to machine layers 24, 26 during initial fabrication of component 22. For example, portions of component 22 that include a defect may have inferior material properties that may propagate to subsequent layers. Computing device 12 may evaluate whether the identified difference exceeds a threshold, such as for machinability or severity. If the identified difference exceeds the threshold, computing device 12 may control machining device 52 to machine the identified difference to within tolerance, such that component 22 may have fewer or less severe internal defects.

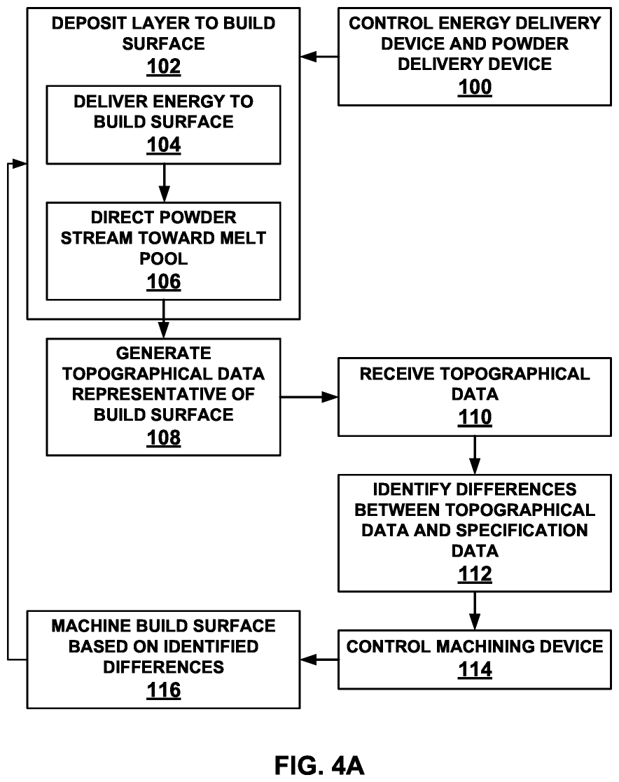

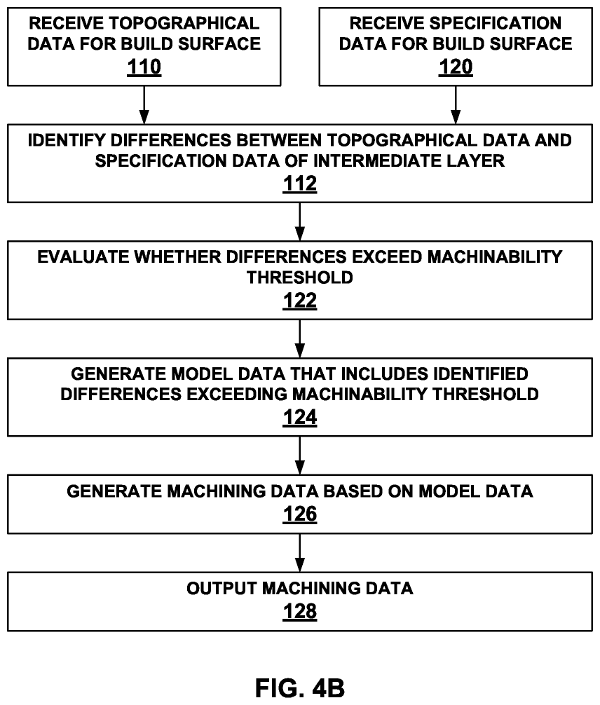

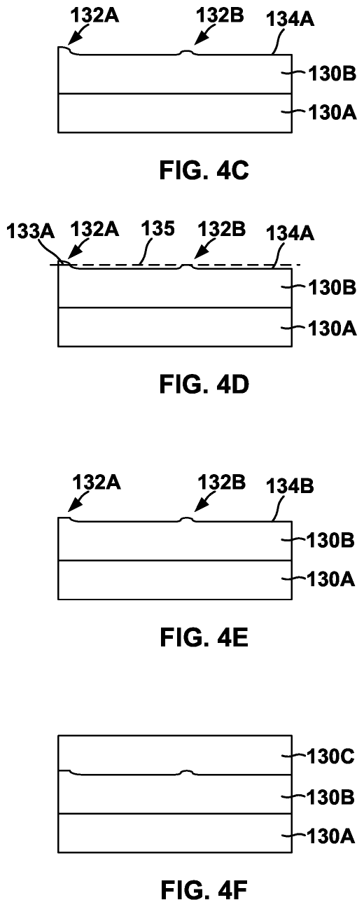

FIG. 4A is a flowchart illustrating an example method for fabricating component 22 using topological data, including machining layers of component 22 during initial fabrication of component 22. The example method of FIG. 4A includes controlling energy delivery device 16 and powder delivery device 14 (100) to deposit a layer on build surface 28 based on a set of deposition parameters (102). For example, computing device 12 may send control signals to each of energy deliver device 16 and powder delivery device 14. In response to receiving the control signals, energy delivery device 16 delivers energy to build surface 28 of component 22 to form melt pool 32 in build surface 28 (104), and powder delivery device 14 directs powder stream 30 toward melt pool 32 (106).

The example method of FIG. 4A include generating, by topology sensor 48, topological data representative of build surface 28 (108). For example, topology sensor 48 may use one or more optical techniques to scan build surface 28 and capture topological data. The topological data may include a topology for a particular layer of the plurality of layers that has just been deposited. The example method of FIG. 3A includes receiving topological data from topology sensor 48 of additive manufacturing system 10 (100). For example, computing device 12 may receive the topological data in real-time as build surface 28 is scanned or at any other time prior to deposition of a subsequent layer on build surface 28.

The example method of FIG. 4A includes identifying, by computing device 12, differences between the topological data and specification data representative of a set of tolerances of build surface 28 (112). The identified differences may represent defects or other anomalies that may affect how the subsequent machining operation is performed, but that would otherwise go unnoticed if not for the captured topological data of each build surface 28.

The example method of FIG. 4A includes controlling, by computing device 12, machining device 52 to machine one or more portions of build surface 28 based on the identified differences (114). For example, computing device 12 may control machining device 52 to machine portions of build surface 28 that may be out of specification until build surface 28 is within tolerance. In response to receiving the control signals, machining device 52 may machine build surface 28 based on the identified differences (116). After machining is complete, the example method includes depositing additional layers on build surface 28 until initial fabrication of component 22 is complete.

FIG. 4B is a flowchart illustrating an example method for generating machining data using topological data. The example method of FIG. 3B may be performed by computing device 12, such that computing device 12 may be configured to perform any of the steps of FIG. 4B. The example method includes receiving topographical data for build surface 28 (110), such as described in step 110 of FIG. 4A above. The example method of FIG. 4B further includes receiving specification data for build surface 28 (120). The specification data may represent an anticipated or desired topology of build surface 28 based on the set of deposition parameters selected for the particular layer.

FIG. 4C is a cross-sectional side view diagram illustrating an intermediate build of a component that includes topological defects 132A and 132B (referred to collectively as “defects 132”), such as may be indicated by topological data. Defects 132 may include any defects on layer 90B that can be indicated by a topology of a build surface 134A of layer 130B and removed through a machining process. In the example of FIG. 4C, defects 132 are indicated by a projection; however, other topological variations may indicate defects 132, such as ridges, overhangs, or any other difference in topology detectable using optical detection techniques and actionable using subtractive manufacturing techniques.

Referring back to FIG. 4B, the example method includes identifying differences between the topological data and specification data representative of a set of tolerances of build surface 28 (112), such as described in step 112 of FIG. 4A above. In some examples, the identified differences include a spatial location of a topological variation that exceeds a tolerance. In some instances, the spatial location may include only the portion of the layer that exceeds the tolerance. For example, a defect that results from localized over-deposition may be limited to that portion of the layer outside the tolerance.

The example method of FIG. 4B includes evaluating whether each of the identified differences exceeds a machinability threshold (122). The machinability threshold may represent a threshold for which removal of the identified difference is not sufficiently valuable and/or feasible based on a capability of machining device 52. For example, an identified difference may not be of a sufficient magnitude (e.g., height or size) to adversely affect an integrity of component 22. Additionally or alternatively, removal of the identified difference may not be within a machining tolerance of machining device 52 and/or sufficiently valuable for the amount of time spent removing the material or potential risk of causing damage to build surface 28.

The example method of FIG. 4B includes generating model data that includes the identified differences (124). The model data may represent an as-deposited model of build surface 28 that is based on the topological data and that includes the identified differences with respect to the machinability threshold. For example, the identified differences may be indicated as spatial locations within the model data. FIG. 4D is a cross-sectional side view diagram illustrating identification of topological defects in an intermediate build of a component. In the example of FIG. 4D, only defect 132A is indicated as a respective regions 133A that includes an identified difference that exceeds a machining threshold 135.

Referring back to FIG. 4B, the example method includes generating machining data based on the model data (126). Machining data may include a toolpath that corresponds to regions 133 to be removed through machining. FIG. 4E is a cross-sectional side view diagram illustrating machining of topological defects 132. Defect 132A is machined to form a new build surface 134B within a desired tolerance. In the example of FIG. 4E, defect 132A is illustrated as being machined to at or below machinability threshold 135; however, in other examples, defect 132A may be machined to a different threshold. For example, defect 132A may be fully machined such as to be in a same plane as a remaining build surface 134B outside of defects 132A and 132B.

Once the identified differences are machined, the example method may include further depositing any subsequent layers on build surface 28. FIG. 4F is a cross-sectional side view diagram illustrating deposition of an overlying layer 130C on machined layer 130B. As a result, defects in an underlying layer 130B may not propagate, or may propagate to a lesser extent, in any subsequent layers 130C.

In some examples, additive manufacturing system 10 may be configured to adaptively deposit subsequent layers of component 22 based on topological data captured during initial fabrication of component 22. A particular set of deposition parameters may result in a layer having a different height than predicted based on the set of deposition parameters. For example, as layers are deposited, small differences between the predicted and deposited height of the layers may propagate over multiple layers, such that final component 22 requires substantial material removal to bring component 22 into specification. These small differences in height may be due to deposition parameters that, individually or collectively, may vary over the course of a build and/or over the course of operation of system 10.

Computing device 12 may be configured to determine whether a layer or sequence of layers exceed the threshold using the topological data and adjust deposition for subsequent layers that account for the set of parameters, such that component 22 more closely matches a target set of dimensions, thereby reducing or eliminating subsequent machining. For example, computing device 12 may be configured to use machine learning techniques that evaluate a set of deposition parameters with respect to the topological data to adjust the set of deposition parameters for subsequent layers.

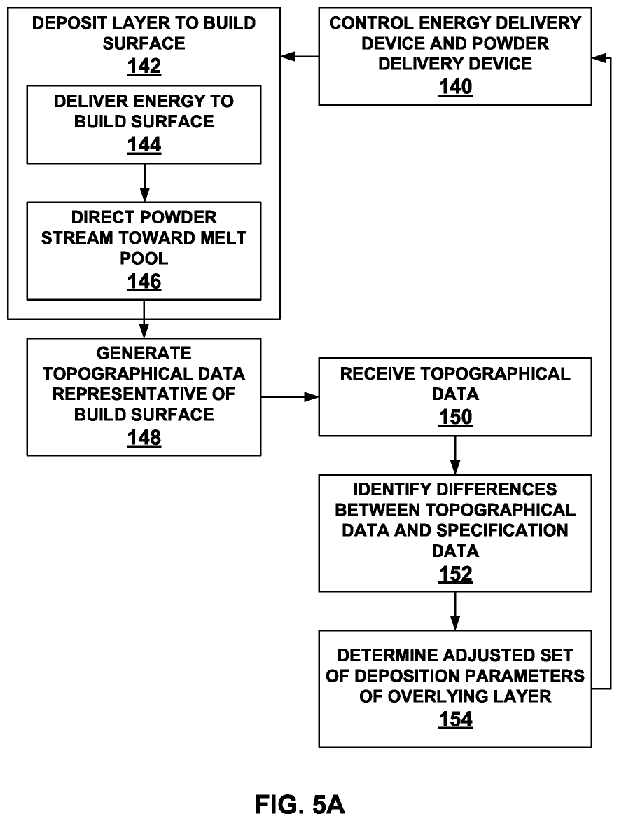

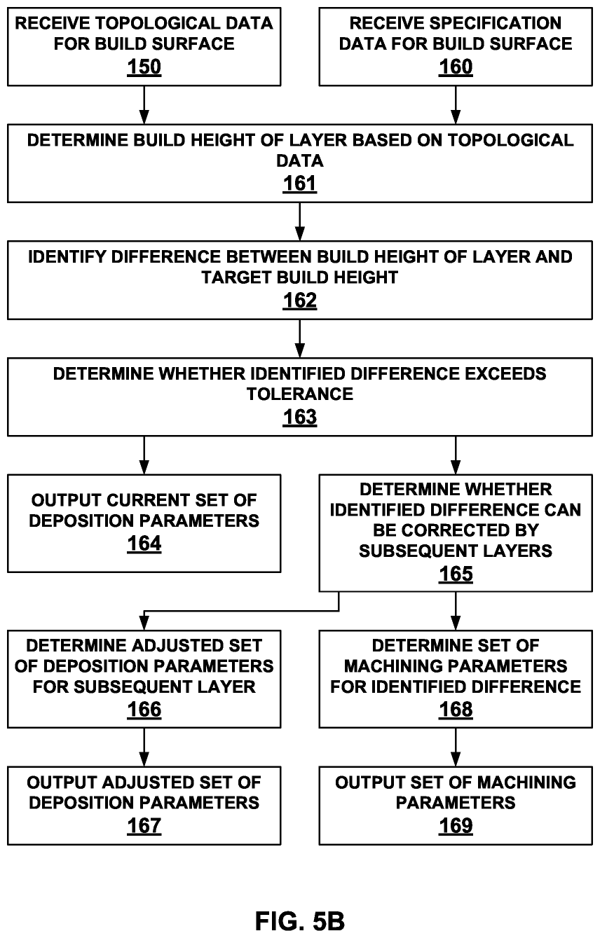

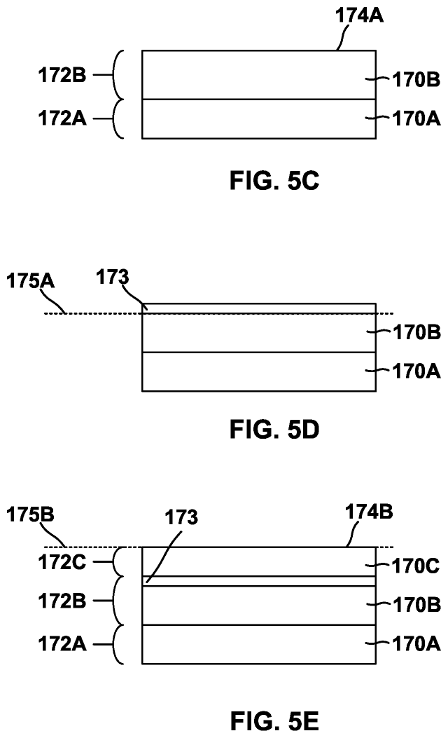

FIG. 5A is a flowchart illustrating an example method for fabricating component 22 using topological data. The example method of FIG. 5A includes controlling energy delivery device 16 and powder delivery device 14 (140) to deposit a layer on build surface 28 based on an initial set of deposition parameters (142). For example, computing device 12 may send control signals to each of energy deliver device 16 and powder delivery device 14. In response to receiving the control signals, energy delivery device 16 delivers energy to build surface 28 of component 22 to form melt pool 32 in build surface 28 (144), and powder delivery device 14 directs powder stream 30 toward melt pool 32 (146).

The example method of FIG. 5A include generating, by topology sensor 48, topological data representative of build surface 28 (148). For example, topology sensor 48 may use one or more optical techniques to scan build surface 28 and capture topological data. The topological data may include a topology for a particular layer of the plurality of layers. The example method of FIG. 5A includes receiving topological data from topology sensor 48 of additive manufacturing system 10 (70). For example, computing device 12 may receive the topological data in real-time as build surface 28 is scanned, prior to deposition of a subsequent layer, or at any other time prior to completion of component 22.

The example method of FIG. 5A includes identifying, by computing device 12, differences between the topological data and specification data representative of a set of tolerances of build surface 28 (152). The identified differences may represent a change in thickness of the particular layer or a sequence of layers. For example, the identified differences may result from an anomalous change in thickness of a particular layer that exceeds a threshold for that particular layer, or may result from a gradual change in thickness over a sequence of layers that exceeds a threshold for the overall build at that particular layer.

The example method of FIG. 5A includes determining an adjusted set of deposition parameters for a subsequent layer based on the identified differences (154). The adjusted set of deposition parameters may be selected to form a subsequent layer or sequence of layers that are within specification and/or that will bring the build into specification. For example, an overlying layer may be deposited that compensates for deviation of a particular layer, or a series of overlying layers may be deposited that compensate for the deviation of a previous sequence of layers. The example method of FIG. 5A includes controlling energy delivery device 16 and powder delivery device 14 (140) to deposit a layer on build surface 28 based on an initial set of deposition parameters (142).

FIG. 5B is a flowchart illustrating an example method for generating subsequent layers using topological data. The example method of FIG. 5B may be performed by computing device 12, such that computing device 12 may be configured to perform any of the steps of FIG. 5B. The example method includes receiving topographical data for build surface 28 (150), such as described in step 150 of FIG. 5A above. The example method of FIG. 5B further includes receiving specification data for build surface 28 (160). The specification data may represent an anticipated or desired topology of build surface 28 based on the set of deposition parameters selected for the particular layer. The specification data may include a target build height that corresponds to the anticipated or desired topology of build surface 28. In some instances, this specification data may represent a build height of the particular layer. For example, the specification data may represent an anticipated or desired difference in build level between the currently deposited layer and the previously deposited layer. In some instances, the specification data may represent a spatial location of build surface 28 for the particular layer in the build of component 22. For example, the specification data may represent an anticipated or desired build height of the deposited layers. The specification data may also include one or more tolerances corresponding to a difference in the current build surface 28 to a build surface of a previous layer and/or a difference in the current build surface 28 to an anticipated build surface at the particular layer in the build. As will be described below, this tolerance may be predetermined, may be determined during the build, or both.

The example method of FIG. 5B includes determining a build height of an as-deposited layer based on the topological data (161). For example, computing device 12 may determine a build height of the layer or a sequence of layers based on a relative difference in the topology of the layer and a reference, such as the topology of the underlying layer. In some examples, the build height may be an average build height of the layer. For example, computing device 12 may determine a spatial average of the topology of build surface 28. In some examples, the build height may be a maximum and/or minimum build height of the layer.

FIG. 5C is a cross-sectional side view diagram illustrating an intermediate build of component 22 that includes a topological deviation from a target build height of a build surface 174A, such as may be indicated by the topological data. The intermediate build includes a first layer 170A having a first build height 172A and a second layer 170B having a second build height 172B, greater than the first thickness. As layers 170 are deposited, deposition conditions may change, resulting in layers having different thicknesses. Such topological deviation may occur despite input parameters remaining substantially the same. In some instances, such topological deviation may be due to an anomalous change in deposition conditions that only affects one to several layers. For example, a restart of the build between layers may result in a first layer after resumption of the build being different from an underlying layer. In some instances, such topological deviation may be due to a gradual change in deposition conditions over a sequence of layers. For example, a change in geometry of component 22 over the sequence of layers may cause different heating or cooling dynamics of the layers, resulting in layers having different thicknesses.

Referring back to FIG. 5B, the example method includes identifying a difference between the build height of the layer and the target build height for the layer (162). The target build height for a layer may correspond to a target build surface relative to an underlying layer, such as determined from a desired thickness of the layer based on the specification data. Computing device 12 may compare the build height for the layer as indicated by the topological data with the target build height as indicated by or determined from the specification data to identify the difference. FIG. 5D is a cross-sectional side view diagram illustrating identification of topological deviation in an intermediate build of component 22. An excess portion 173 of layer 170B may exceed a target build surface 175A. Target build surface 175A may represent the target build height of build surface 28. In some examples, target build surface 175A may be defined with respect to a previous deposition height of underlying layer 170A, such that reference surface 175A may represent a projected build surface for a target build height of layer 170B. In some examples, reference surface 175A may be defined with respect to an overall height of some or all underlying layers 170, such that target build height 175A may represent a target spatial position of build surface 174A of layer 170B.

Referring back to FIG. 5B, the example method includes determining whether the identified difference exceed a threshold (163). As mentioned above, the specification data may include tolerances related to a thickness of a layer and/or a height of build surface 174A for a particular layer within the build. This tolerance may account for instrument error of topology sensor 48 and/or random variation between layers that does not indicate a change in deposition conditions that requires compensation. Computing device 12 may determine whether excess portion 173 exceeds the tolerance to determine whether to modify the set of deposition parameters for any overlying layers.

In response to determining that the identified difference does not exceed the tolerance, the method includes outputting a current set of deposition parameters. For example, computing device 12 may continue to deposit subsequent layers until a layer has a build height that exceeds the tolerance. In response to receiving the initial set of deposition parameters, energy delivery device 16 and powder delivery device 14 may deposit the subsequent layer based on the initial set of deposition parameters.

In response to determining that the identified difference exceeds the tolerance, the example method includes determine an adjusted set of deposition parameters of a subsequent layer (166). The adjusted set of deposition parameters are different from the set of deposition parameters of an underlying layer. The adjusted set of deposition parameters may include at least one of a thickness of a respective layer, a power of the energy delivery device, a size of the melt pool, a feed rate of the powder stream, a travel speed of the powder stream relative to the build surface, or a tool path of melt pool along the build surface 28. The method may include outputting the adjusted set of deposition parameters (167); in response, energy delivery device 16 and powder delivery device 14 deposit the subsequent layer based on the adjusted set of deposition parameters.

FIG. 5E is a cross-sectional side view diagram illustrating deposition of a subsequent layer that accounts for the topological defects of the underlying layer. In some examples, the adjusted set of deposition parameters may be selected to compensate for a previous topological deviation in an underlying layer. For example, the adjusted set of deposition parameters for layer 170C may result in layer 170C having a lower thickness to compensate for a higher thickness of layer 170B. Such compensation may be particularly useful for anomalous thickness deviations that may not manifest in subsequent layers. In some examples, the adjusted set of deposition parameters may be selected to compensate for a change in anticipated build height that results from a change in deposition conditions. For example, the adjusted set of deposition conditions for layer 170C may result in layer 170C having a build height that corresponds to a desired build height.

Referring back to FIG. 5B, in some examples, determining an adjusted set of deposition conditions may include only determining an adjusted set of deposition conditions for a particular portion of a subsequent layer and using an existing set of deposition conditions for a remainder of the subsequent layer. For example, the topological data may indicate that only a portion of build surface deviates from the target build surface beyond the threshold. Computing device 12 may identify those portions and determine the adjusted set of deposition parameters for those portions. Computing device 12 may output the adjusted set of deposition parameters to cause energy delivery device 16 and powder delivery device 14 to deposit portions of the subsequent layer overlying the identified difference based on the adjusted set of deposition parameters and deposit portions of the subsequent layer that are not overlying an identified difference based on the initial set of deposition parameters.

In some examples, the adjusted set of deposition parameters may be selected using machine learning techniques. For example, a particular build height of a layer may be related to a combination of deposition parameters. The particular combination of deposition parameters may vary depending on a progression of a build, an environment in which the build is performed, a geometry of component 22, or the like. Computing device may determine one or more relationships between a build height of the layer and one or more training sets of deposition parameters based on topological data. Computing device 12 may use the topological data as feedback for determining the build height produced by the training sets of deposition parameters. The topological data and training sets of deposition conditions may include topological data and sets of deposition conditions for other layers in the same build of component 22, for other layers of other builds of similar components as component 22, and/or for other layers of other builds for dissimilar components as component 22. Computing device 12 may use machine learning algorithms to determine relationships between various sets of deposition parameters and determine the adjusted set of parameters for a particular layer based on these relationships.

In some examples, the method of FIG. 5B includes determining whether the identified difference can be corrected through adjustment of deposition of subsequent layers (165). For example, the specification data may further include one or more thresholds related to a maximum permitted deviation of a build height from the target build height. This threshold may be related to an integrity of component 22, as a substantial deviation may indicate a defect that may require correction. In response to determining that the identified difference cannot be corrected through deposition of subsequent layers, the method may include determining a set of machining parameters for machining at least a portion of build surface 28 that includes the respective identified difference (168) and outputting the set of machining parameters to a machining device (169). For example, the set of machining parameters may include a location of particular portions of build surface that exceed the threshold.

The evaluation described in steps 150 and 161-167 may continue for subsequent layers. For example, computing device 12 may receive topological data from topology sensor 48 for the subsequent layer deposited according to the previously adjusted set of deposition parameters (150). Computing device 12 may determine a build height of the subsequent layer based on the topological data for the subsequent layer (161), identify a difference between the build height of the subsequent layer and a target build height of the subsequent layer (162), determine whether the identified difference exceeds the tolerance (163) and control energy delivery device 16 and powder delivery device 14 to deposit the subsequent layer based on whether the identified difference exceeds the tolerance (164, 166, 167).

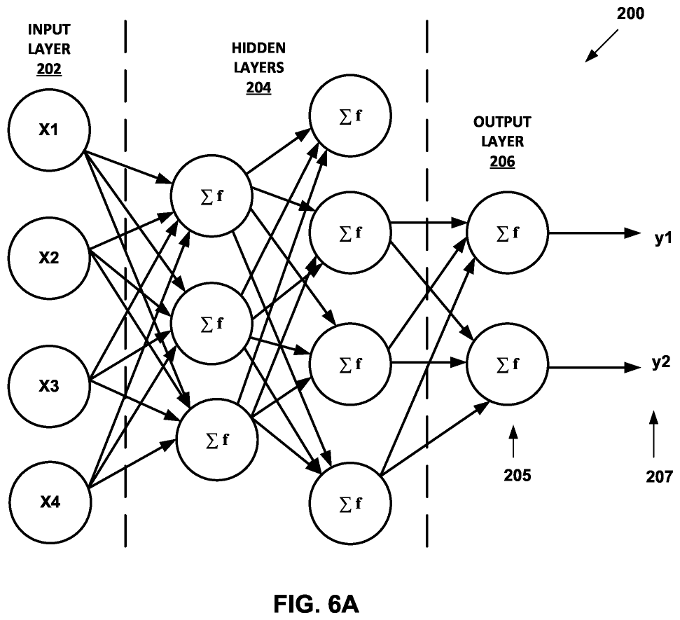

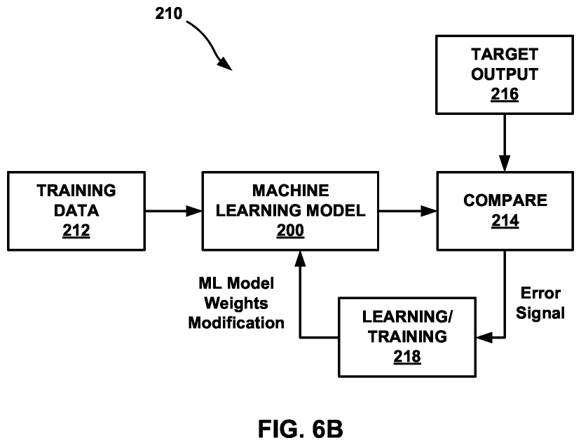

As explained above, additive manufacturing systems described herein may be configured to use machine learning processes for evaluating a set of deposition parameters with respect to topological data to adjust the set of deposition parameters for subsequent layers. FIG. 6A is a conceptual diagram illustrating an example machine learning model according to one or more aspects of this disclosure. Machine learning model 200 may be an example of a machine learning model implemented by computing device 12. Machine learning model 200 may be an example of a deep learning model, or deep learning algorithm, trained to determine deposition parameters for subsequent layers. Computing device 12 and/or another device, may train, store, and/or utilize machine learning model 200, but other devices of system 10 may apply inputs to machine learning model 200. In some examples, other types of machine learning and deep learning models or algorithms may be utilized. For example, a convolutional neural network model of ResNet-18 may be used. Some non-limiting examples of models that may be used for transfer learning include AlexNet, VGGNet, GoogleNet, ResNet50, or DenseNet, etc. Some non-limiting examples of machine learning techniques include Support Vector Machines, K-Nearest Neighbor algorithm, and Multi-layer Perceptron.

As shown in the example of FIG. 6A, machine learning model 200 may include three types of layers. These three types of layers include input layer 202, hidden layers 204, and output layer 206. Output layer 206 includes the output from the transfer function 205 of output layer 206. Input layer 202 represents each of the input values X1 through X4 provided to machine learning model 200. In some examples, the input values may include any of the values input into the machine learning model, as described above. For example, the input values may include topological data from topology sensor 48, or other data received by computing device 12, as described above. In addition, in some examples input values of machine learning model 200 may include additional data, such as other data that may be collected by or stored in system 200.

Each of the input values for each node in the input layer 202 is provided to each node of a first layer of hidden layers 204. In the example of FIG. 6A, hidden layers 204 include two layers, one layer having four nodes and the other layer having three nodes, but fewer or greater number of nodes may be used in other examples. Each input from input layer 202 is multiplied by a weight and then summed at each node of hidden layers 204. During training of machine learning model 200, the weights for each input are adjusted to establish a relationship between topological data and deposition parameters that generate the layer represented by the topological data. In some examples, one hidden layer may be incorporated into machine learning model 200, or three or more hidden layers may be incorporated into machine learning model 200, where each layer includes the same or different number of nodes.

The result of each node within hidden layers 204 is applied to the transfer function of output layer 206. The transfer function may be linear or non-linear, depending on the number of layers within machine learning model 200. Example non-linear transfer functions may be a sigmoid function or a rectifier function. The output 207 of the transfer function may be a set of deposition parameters that correspond to the layer represented by the topological data and having a desired thickness.

As shown in the example above, by applying machine learning model 200 to input data such as image data, processing circuitry of computing device 12 is able to determine a relationship between deposition parameters that produce a layer based on the topological data. Computing device 12 may utilize such features to determine a local coordinate system, to map the local coordinate system to a global coordinate system, and/or to generate representations of the layer and/or layers.

FIG. 6B is a conceptual diagram illustrating an example training process for a machine learning model according to one or more aspects of this disclosure. Process 210 may be used to train machine learning model 200. Machine learning model 200 may be implemented using any number of models for supervised and/or reinforcement learning, such as but not limited to, an artificial neural network, a decision tree, naïve Bayes network, support vector machine, or k-nearest neighbor model, CNN, RNN, LSTM, ensemble network, to name only a few examples.

In some examples, computing device 12 or another device trains machine learning model 100 based on a corpus of training data 212. Training data 212 may include, for example, previous topological data of a build over time, previous deposition parameter data, and/or the like. Previous deposition parameter data, for example, may include deposition parameters associated with previous additive manufacturing processes. In some examples, the topological data and/or deposition parameter data may be generated by executing a natural language processing application on content of a plurality of operational records to automatically extract relevant nor desired training data. For example, by using an NLP model, computing device 12 may capture potentially cofounding operation conditions or factors, which may be useful in determining a set of deposition parameters. Computing device 12 may use the NLP model to capture such details.

In some examples, training data 212 may include annotations identifying effects of deposition parameters indicated in topological data of training data 212. Training data 212 may include data from past additive deposition processes performed on components having different geometries, formed from different materials, formed under different conditions, and/or the like.

While training machine learning model 200, computing device 12 may compare 214 a prediction or classification with a target output 216. Computing device 12 may utilize an error signal from the comparison to train (learning/training 218) machine learning model 200. Computing device 12 may generate machine learning model weights or other modifications which computing device 12 may use to modify machine learning model 200. For example, computing device 12 may modify the weights of machine learning model 200 based on the learning/training 218.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Example 1: An additive manufacturing system includes an energy delivery device configured to deliver energy to a build surface of a component to form a melt pool in the build surface of the component; a powder delivery device configured to direct a powder stream toward the melt pool; a machining device configured to machine the build surface; one or more sensors includes receive the topological data from the at least one topology sensor for a plurality of layers; identify differences between the topological data and specification data representative of a set of tolerances of the build surface; control the energy delivery device and the powder delivery device to deposit the plurality of layers based on a set of deposition parameters; and control the machining device to machine the build surface based on the identified differences.

Example 2: The additive manufacturing system of example 1, wherein the computing device is configured to identify at least one of the identified differences as a defect corresponding to a different density.

Example 3: The additive manufacturing system of any of examples 1 and 2, wherein the plurality of layers includes a plurality of intermediate layers, and wherein at least one difference of the identified differences is identified in an intermediate layer of the plurality of intermediate layers.

Example 4: The additive manufacturing system of example 3, wherein the computing device is further configured to generate model data that includes the identified differences.

Example 5: The additive manufacturing system of example 4, wherein, to control the machining device, the computing device is configured to: generate machining data based on the model data; and output the machining data to the machining device.

Example 6: The additive manufacturing system of example 5, wherein the machining data includes: a toolpath; a first set of machining parameters for portions of the toolpath that do not include the identified differences; and a second set of machining parameters for portions of the toolpath that include the identified differences, wherein at least one machining parameter of the second set of machining parameters is different from the first set of machining parameters.

Example 7: The additive manufacturing system of example 6, wherein the at least one machining parameter includes a change in material removal rate.

Example 8: The additive manufacturing system of any of examples 3 through 7, wherein the computing device is configured to, for an intermediate layer of the plurality of intermediate layers: identify the at least one difference for the intermediate layer; control the machining device to machine the build surface based on the at least one difference; and after machining the build surface, control the energy delivery device and the powder delivery device to deposit a subsequent layer on the intermediate layer.

Example 9: The additive manufacturing system of any of examples 1 through 8,wherein the computing device is further configured to: evaluate whether at least one difference exceeds a machinability threshold; and in response to the at least one difference exceeding the machinability threshold, controlling the machining device to machine the build surface.

Example 10: The additive manufacturing system of any of examples 1 through 9, wherein the at least one topology sensor is configured to measure a topology of material added to the melt pool.

Example 11: A method for additive manufacturing includes receiving, by a computing device, topological data for a plurality of layers from one or more sensors of an additive manufacturing system, wherein the topological data is representative of a topology of a build surface of each layer of the plurality of layers; identifying, by the computing device, differences between the topological data and specification data representative of a set of tolerances of the build surface; controlling, by the computing device and based on a set of deposition parameters, an energy delivery device to deliver energy to the build surface to form a melt pool and a powder delivery device to direct a powder stream toward the melt pool; and controlling, by the computing device, a machining device to machine the build surface based on the identified differences.

Example 12: The method of example 11, further comprising identifying at least one of the identified differences as a defect corresponding to a different density.

Example 13: The method of any of examples 11 and 12, wherein the plurality of layers includes a plurality of intermediate layers, and wherein at least one difference of the identified differences is identified in an intermediate layer of the plurality of intermediate layers.

Example 14: The method of example 13, further comprising generating as-deposited model data that includes the identified differences.

Example 15: The method of example 14, wherein controlling the machining device includes: generating machining data based on the as-deposited model data; and outputting the machining data to the machining device.

Example 16: The method of example 15, wherein the machining data includes: a toolpath; a first set of machining parameters for portions of the toolpath that do not include the identified differences; and a second set of machining parameters for portions of the toolpath that include the identified differences, wherein at least one machining parameter of the second set of machining parameters is different from the first set of machining parameters.

Example 17: The method of example 16, wherein the at least one machining parameter includes a change in material removal rate.

Example 18: The method of any of examples 13 through 17, further includes identifying the at least one difference for the intermediate layer; controlling the machining device to machine the build surface based on the at least one difference; and after machining the build surface, controlling the energy delivery device and the powder delivery device to deposit a subsequent layer on the intermediate layer.

Example 19: The method of any of examples 11 through 18, further includes evaluating whether at least one difference exceeds a machinability threshold; and in response to the at least one difference exceeding the machinability threshold, controlling the machining device to machine the build surface.

Example 20: The method of any of examples 11 through 19, wherein the at least one topology sensor is configured to measure a topology of material added to the melt pool.

Various examples have been described. These and other examples are within the scope of the following claims.

What is claimed is:

1. An additive manufacturing system, comprising:
an energy delivery device configured to deliver energy to a build surface of a component to form a melt pool in the build surface of the component;
a powder delivery device configured to direct a powder stream toward the melt pool;
a machining device configured to machine the build surface;
one or more sensors comprising at least one topology sensor configured to generate topological data representative of a topology of the build surface; and
a computing device configured to:
receive the topological data from the at least one topology sensor for a plurality of layers;
identify differences between the topological data and specification data representative of a set of tolerances of the build surface;
control the energy delivery device and the powder delivery device to deposit the plurality of layers based on a set of deposition parameters; and
control the machining device to machine the build surface based on the identified differences.

2. The additive manufacturing system of claim 1, wherein the computing device is configured to identify at least one of the identified differences as a defect corresponding to a different density.

3. The additive manufacturing system of claim 1,
wherein the plurality of layers includes a plurality of intermediate layers, and
wherein at least one difference of the identified differences is identified in an intermediate layer of the plurality of intermediate layers.

4. The additive manufacturing system of claim 3, wherein the computing device is further configured to generate model data that includes the identified differences.

5. The additive manufacturing system of claim 4, wherein, to control the machining device, the computing device is configured to:
generate machining data based on the model data; and
output the machining data to the machining device.

6. The additive manufacturing system of claim 5, wherein the machining data includes:
a toolpath;
a first set of machining parameters for portions of the toolpath that do not include the identified differences; and
a second set of machining parameters for portions of the toolpath that include the identified differences, wherein at least one machining parameter of the second set of machining parameters is different from the first set of machining parameters.

7. The additive manufacturing system of claim 6, wherein the at least one machining parameter includes a change in material removal rate.

8. The additive manufacturing system of claim 3, wherein the computing device is configured to, for an intermediate layer of the plurality of intermediate layers:
identify the at least one difference for the intermediate layer;
control the machining device to machine the build surface based on the at least one difference; and
after machining the build surface, control the energy delivery device and the powder delivery device to deposit a subsequent layer on the intermediate layer.

9. The additive manufacturing system of claim 1, wherein the computing device is further configured to:
evaluate whether at least one difference exceeds a machinability threshold; and
in response to the at least one difference exceeding the machinability threshold, controlling the machining device to machine the build surface.

10. The additive manufacturing system of claim 1, wherein the at least one topology sensor is configured to measure a topology of material added to the melt pool.

11. A method for additive manufacturing, comprising:
receiving, by a computing device, topological data for a plurality of layers from one or more sensors of an additive manufacturing system, wherein the topological data is representative of a topology of a build surface of each layer of the plurality of layers;
identifying, by the computing device, differences between the topological data and specification data representative of a set of tolerances of the build surface;
controlling, by the computing device and based on a set of deposition parameters, an energy delivery device to deliver energy to the build surface to form a melt pool and a powder delivery device to direct a powder stream toward the melt pool; and
controlling, by the computing device, a machining device to machine the build surface based on the identified differences.

12. The method of claim 11, further comprising identifying at least one of the identified differences as a defect corresponding to a different density.

13. The method of claim 11,
wherein the plurality of layers includes a plurality of intermediate layers, and
wherein at least one difference of the identified differences is identified in an intermediate layer of the plurality of intermediate layers.

14. The method of claim 13, further comprising generating as-deposited model data that includes the identified differences.

15. The method of claim 14, wherein controlling the machining device includes:
generating machining data based on the as-deposited model data; and
outputting the machining data to the machining device.

16. The method of claim 15, wherein the machining data includes:
a toolpath;
a first set of machining parameters for portions of the toolpath that do not include the identified differences; and
a second set of machining parameters for portions of the toolpath that include the identified differences, wherein at least one machining parameter of the second set of machining parameters is different from the first set of machining parameters.

17. The method of claim 16, wherein the at least one machining parameter includes a change in material removal rate.

18. The method of claim 13, further comprising, for an intermediate layer:
identifying the at least one difference for the intermediate layer;
controlling the machining device to machine the build surface based on the at least one difference; and
after machining the build surface, controlling the energy delivery device and the powder delivery device to deposit a subsequent layer on the intermediate layer.

19. The method of claim 11, further comprising:
evaluating whether at least one difference exceeds a machinability threshold; and
in response to the at least one difference exceeding the machinability threshold, controlling the machining device to machine the build surface.

20. The method of claim 11, wherein the at least one topology sensor is configured to measure a topology of material added to the melt pool.
